(19) United States
(12) Patent Application Publication
(10) Pub. No.: US 2024/0053761 A1
(43) Pub. Date: Feb. 15, 2024

(54) Method to Use Depth Sensors on the Bottom of Legged Robot for Stair Climbing

(71) Applicant: Ghost Robotics Corporation, Philadelphia, PA (US)

(72) Inventors: Gavin Kenneally, Philadelphia, PA (US); Vinh Q. Nguyen, Philadelphia, PA (US); Thomas Turner Topping, Philadelphia, PA (US); Avik De, Philadelphia, PA (US)

(21) Appl. No.: 18/231,497

(22) Filed: Aug. 8, 2023

Related U.S. Application Data
(60) Provisional application No. 63/396,319, filed on Aug. 9, 2022.

(51) Int. Cl. G05D 1/02; B62D 57/024; G06T 7/50; G06T 7/60

(52) U.S. Cl. CPC G05D 1/0251; B62D 57/024; G06T 7/50; G06T 7/60; G06T 2207/10028

(57) ABSTRACT

The present invention pertains to a system method for using depth sensors on the fore, aft and bottom sides of a legged robot for stair climbing. The method uses real-time depth information to help with a legged robot's navigation on a variety of leveled terrains. Sensing methods are employed in addition to generating a composite field of view stretching from the front to the back of the legged robot. Downward facing depth cameras positioned at a particular angle enable the system to guide a legged robot over an environment which is being navigated by offering a persistent view of the environment. Other tools such as heightmap filling gradient map calculation, and strategic foothold selection are also implemented.

### CROSS REFERENCE TO RELATED APPLICATIONS

This application claims the benefit of U.S. Provisional Patent Application Ser. No. 63/396,319 filed on Aug. 9, 2022, the contents of which are incorporated herein by reference.

### BACKGROUND OF THE INVENTION

The use of depth information and real-time image information is essential in robotic navigation. In legged robots, these sensors are required to create a representation of the terrain around the robot that is accurate and dense enough to search for footholds. Additionally, the representation needs to be updated without delay as the robot rapidly moves through this environment, since there is usually a short window of time in which a safe foothold is determined.

One method of creating this representation that has been commonly used in the past is accumulating measurements over time to create a “map” of the terrain around the robot. This method relies on state estimation or odometry to maintain an understanding of the robot's relative motion to the terrain and using that knowledge to create a combined terrain map. These odometry methods may use a combination of visual, inertial, and encoder measurements. The benefit of this common method is that only a few depth sensors may be required, since the data is assumed to be accumulated over time. However, the frequent footfalls in legged robots present as noise in inertial data, and toe slip can introduce large errors in the incorporation of encoder, inertial, and visual data. If the state estimation result is sufficiently inaccurate due to the aforementioned reasons, there is no possibility of recovery since the depth sensors may not have immediate visibility of the terrain near the robot feet. Further, the approach of combining multiple measurements over time often assumes the environments remain relatively unchanged and static, which does not always hold true.

To avoid this estimation error and ultimately achieve desirable and accurate results when operating vision-enabled legged locomotion on staircases, the composite field of view stretching from just in front of the robot to just behind it may be persistent and updated at a rate conducive to legged locomotion. Adding additional “downward facing” depth and visual sensors, create a comprehensive and composite field of view which covers the region in which a legged robot may tread.

The present invention positions a plurality of depth cameras in various localities on a legged robot, in particular, at the front, back and beneath the center of the robot's chassis. By positioning depth cameras at specific angles, more reliable results regarding vision-enabled legged locomotion are generated by providing a composite field of view that stretches along to the front, center and back of a legged robot using depth cameras, and depth and visual sensors. This approach employs a method that creates more accurate and safer tread for a legged robot on a staircase.

### SUMMARY OF THE INVENTION

The present invention utilizes a plurality of depth cameras positioned in the base of a robot's chassis, as well as the front and back of the legged robot. The cameras provide an all-encompassing view of the terrain surrounding the robot and beneath the robot. Depth information is obtained by way of these cameras in the form of a pointcloud, and pointcloud data is used to aid in the robot's stair climbing. This pointcloud data is processed by eliminating occlusions from parts of the robot's body and used for the creation of a heightmap. Each element within the heightmap holds terrain height information, and a stair model fitting is performed to execute a stair's height and run dimensions. This model fills the missing regions of the heightmaps and allows the legged robot to move through a staircase, or elevated terrain.

Later, a gradient map is calculated on the heightmap, which is essential in the foothold selection process. The combination of these techniques helps legged robots climb stairs while they utilize the depth information from the plurality of cameras affixed to the robot's body and enhance its perception and decision-making during the navigation process.

The present invention's depth camera positions provide a comprehensive field of view. Legged robots that only have front and back cameras do not properly observe the terrain beneath them, and an estimation of the height of the terrain. Moreover, the estimation is difficult because of the need for accurate foot placement despite the presence of measurement noise, and impossible to re-initialize in the event of accumulated inaccuracy in the estimate. In an effort to mitigate this estimation problem, the present invention is disclosing a system design outfitted with a plurality of cameras that cover a full field view of the front, back, and beneath its feet.

The present invention employs a plurality of depth cameras to capture visual data, however, any assortment of cameras that accurately capture depth images with a wide field of view and generates depth data at a sufficiently high rate. The images acquired are, in turn, converted to pointcloud information regarding the height of the surrounding environment, including that of which is underneath the robot. The camera is strategically positioned on the robot at the front, tilted downward at an angle of, by way of example and not limitation, 25 degrees. Another camera is positioned on the back, also facing downward but at a slight angle of 15 degrees. There are also cameras located in the robot's belly, facing directly downward with an inclination of 10 degrees relative to the horizontal line. When the robot's height exceeds 330 cm, these cameras effectively cover the entire field of view beneath the robot. This configuration ensures comprehensive visual coverage and facilitates robust data collection for the robot's navigation and perception tasks.

Next, the present invention generates a heightmap from the pointcloud. The plurality of cameras offer a wide range of field of views, and thus provide depth information about the areas beneath, in front and behind the robot. However, during climbing maneuvers, the robot legs may enter the field of view of the cameras, potentially causing confusion in the depth information of the environment. To address this issue, a slicing strategy is implemented to mitigate the impact of the legs on the depth pointcloud. This heightmap processing is typically relayed by way of a computing box stationed inside of the legged robot that features a microprocessor and inertial memory unit.

The kinematics of the robot's legs are utilized to determine the width of the point cloud slice. By using the toe positions as determined by the kinematics, the range in the y direction of the point cloud slice is established to form the heightmap. Specifically, the minimum y position of the left toes and the maximum y position of the right toes are employed to define this range.

Upon obtaining the pointcloud slice without toe occlusion, heightmap information is generated. The heightmap consists of several elements storing the height of the terrain. The heightmap is a accumulates spatially consistent point cloud data into a more concise and spatially ordered structure, facilitating operations like gradients, and reducing computation time for dependent algorithms.

The present invention also orchestrates stair model fitting. When a legged robot is traversing stairs, the distance between the robot itself and the stairs may be less than 330 cm, leading to incomplete views captured by the cameras. To address this issue, a stair fitting algorithm is employed. A stair fitting algorithm is executed by way of a processor that inhabits the computing box affixed to a legged robot's chassis and operates over wireless network.

The algorithm begins by assuming that the stair steps are uniform and models the staircases using two parameters, height and run. It proceeds by calculating the fitting error for each combination of height and run and incrementally changing these parameters with a step of 1 cm. This process persists until all the fitting errors have been computed for all possible height and run combinations. Subsequently, the algorithm selects the best result with the smallest fitting errors.

The process of foothold selection utilizes a multi-objective optimization search (equation 1). The first two terms are: the cost of deviating from nominal foothold location (Jₙₒₘ) and the gradient at the current location (J_{grad}). Jₙₒₘ is proportional to the distance between the current location and the nominal foothold location. The nominal foothold is the toe location based on the robot's dynamics. J_{grad} is calculated based on the gradient map. This combination dually ensures a consideration of both proximity to the desired foothold position and the terrain's slope.

To enhance stability and prevent excessive movement of the foothold location in the presence of a noisy heightmap, a damping term, J_{damp}, is introduced to the present invention. The damping term penalizes discrepancies between the current foothold location and its previous position. As a result, the foothold selection process is more robust, providing a smoother and more controlled foothold placement even in challenging, uncertain and or unstructured terrain conditions. The objective function is equation 1.

J=wₙₒₘJₙₒₘ+w_{grad}J_{grad}+w_{damp}J_{damp} (1)

In the present invention's stair model fitting method, the robot, in theory, is allowed to step at any location. However, with the gradient map, the robot should prefer to step in more flat areas than uneven areas. The stair model yields the optimal height and run, and the missing regions in the heightmap are filled by way of the algorithm employed. This enhances the perception of terrain during stair traversal, thus enabling the robot to make more strategic, and informed decisions when navigating stairs.

The gradient map calculation discloses how suitable the location in the map is for the legged robot to place its feet. This method does not employ a 3D signed distance field calculated from a terrain map, but rather, a convolution operation. This is a feature designed to aid in sensory data processing and anomaly detection. The outcome, with all features considered, results in an advanced method to use depth sensors positioned on a legged robot for efficient and accurate stair climbing operations.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

FIG. 1 depicts a comparison of the current “state-of-the-art” in legged robotics on the left (without downward facing) in which the robot uses fore and aft depth sensors.

FIG. 2 is a depiction of a robot's tread on a stair.

FIG. 3 is a design diagram of the positions of depth cameras.

FIG. 4 is a view of the positions of the depth cameras.

FIG. 5 is a slice of pointcloud is used to form the heightmap based on the positions of the toes.

FIG. 6 is the process of generating heightmap from pointcloud.

FIG. 7 is a representation of a heightmap and gradient map on a staircase.

The various embodiments are illustrated by way of example, and not by way of limitation, in the figures of the accompanying drawings. Having thus described the invention in general terms, reference will now be made to the accompanying drawings, which are not necessarily drawn to scale, and wherein:

### DETAILED DESCRIPTION OF THE PREFERRED EMBODIMENT

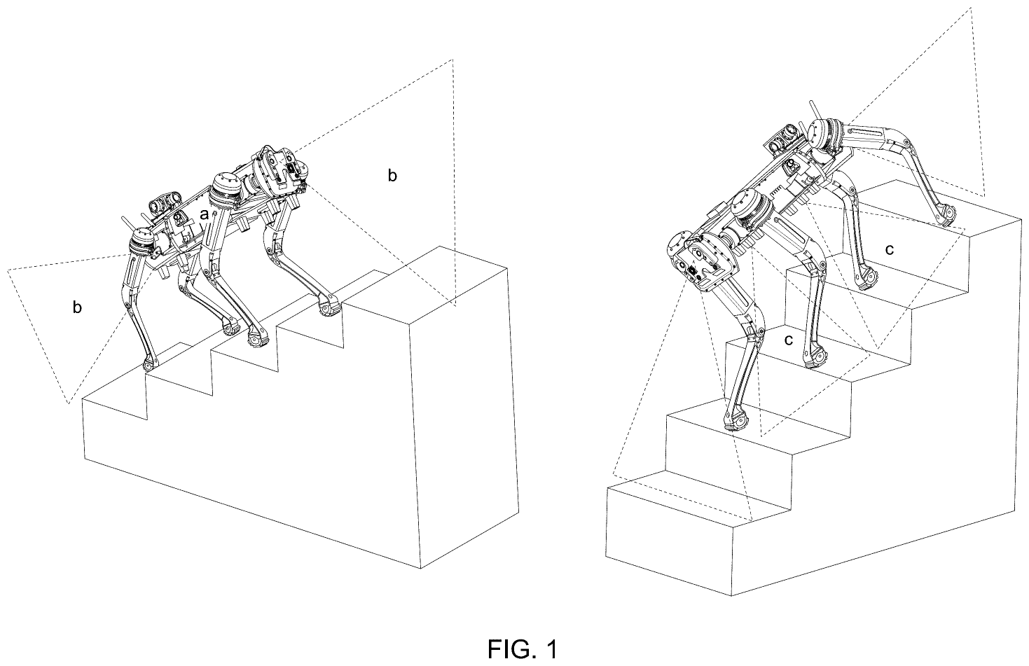

FIG. 1 depicts a comparison of the current “state-of-the-art” in legged robotics on the left (without downward facing visual and depth sensors) in which the robot (a) uses fore and aft cameras, the fields of view (FOVs) of which (b) can develop a model of the environment. On the right-hand side, the addition of downward facing depth sensors and their FOVs (c) instead offer a persistent and complete view of the environment being navigated, without the need for estimation techniques; such approach is more robust to system and sensor noise.

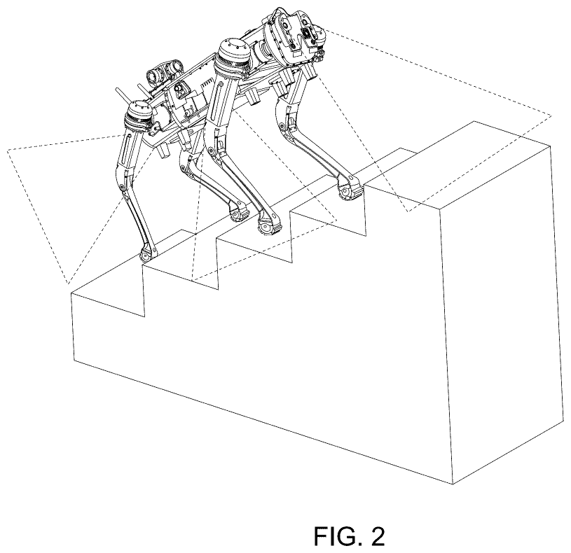

FIG. 2 is a depiction of the legged robot guiding themselves up the stairs. The legged robot is utilizing the operation as disclosed above, which utilizes cameras placed at the front, back and center chassis of the legged robot.

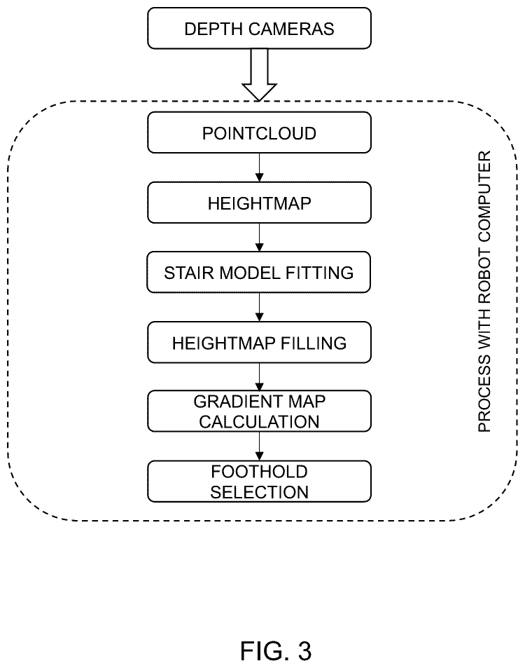

FIG. 3 is the process of utilizing perception information to enable stair climbing. The depth cameras run a series of operations with the robot computer. The point cloud data aids in the design of the heightmap, which is used for the stair model fitting. Then, the gradient map calculations using a 1D convolution operation is created which helps describe the suitability of the location in the map to put the legged robot's feet on. Lastly, in the process of foothold selection, the multi-objective optimization search which uses the equation J=wₙₒₘJₙₒₘ+w_{grad}J_{grad}+w_{damp}J_{damp} (1) helps determine if the distance from the nominal foothold location and the gradient at the current location is proportional to the distance between the current location and nominal foothold location. This equation helps enhance stability and prevent excess movement of the foothold location in a noisy heightmap.

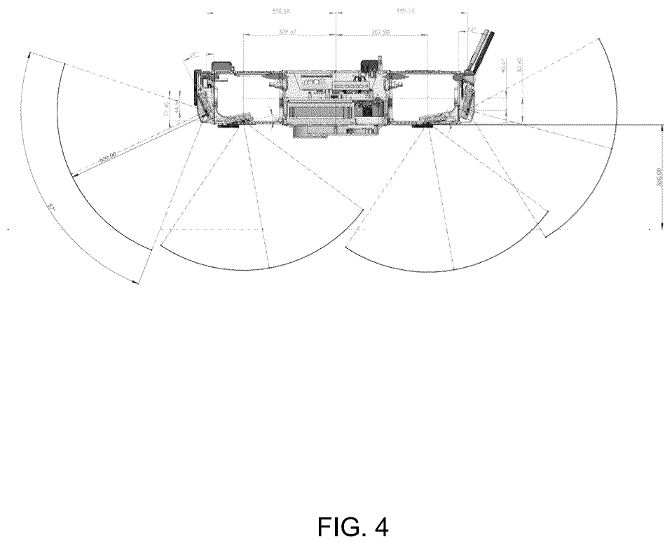

FIG. 4 is a design diagram of positions of depth cameras. One camera is in front, slightly facing down 25 degrees; one camera in the back, slightly facing down 15 degrees; and two cameras are put in the robot's belly, facing downward at the angle of 10 degrees compared to the horizontal line.

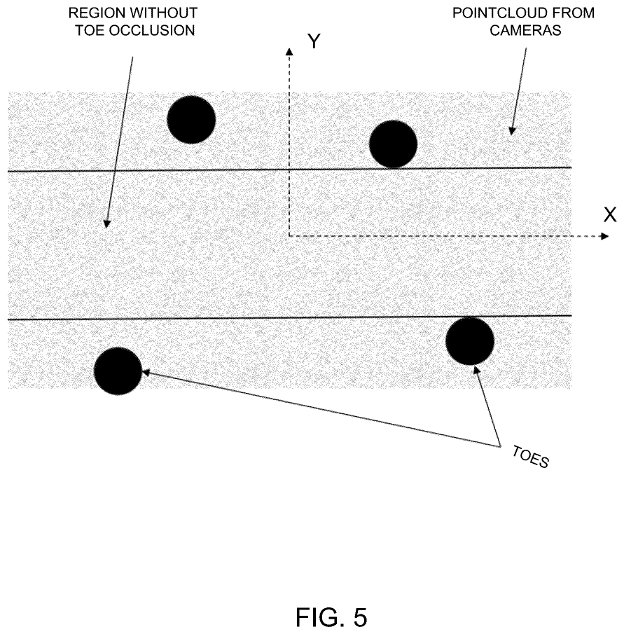

FIG. 5 is a slice of pointcloud is used to form the heightmap based on the positions of the toes. To address the issue of the toes and lower links causing confusion as a result of the depth information of the environment, a slicing strategy is implemented to mitigate the impact of the legs on the depth point cloud.

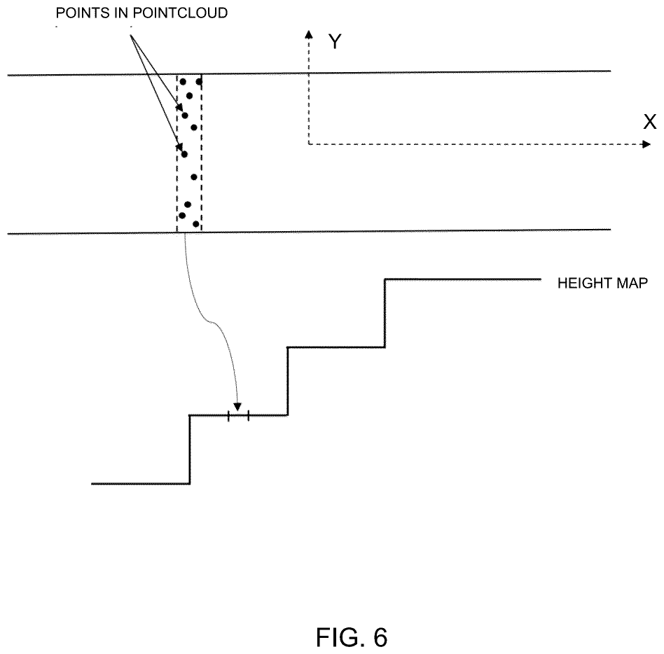

FIG. 6 is a representation of heightmap creation process from the pointcloud. The heightmap is essentially a 1D vector, with each element storing the height of the terrain. All points in the pointcloud with the same y-position are grouped together. The corresponding element of the heightmap is set to the average value of all points within the group.

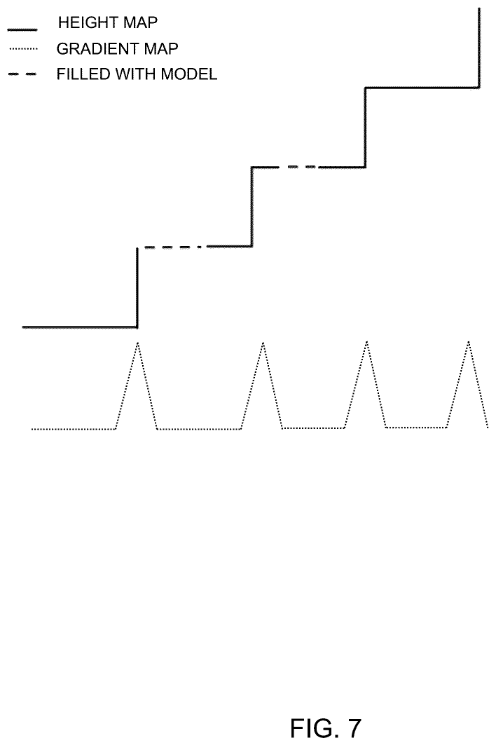

FIG. 7 is a representation of the heightmap (dashed and solid line) and gradient map (dotted). Missing regions of heightmap are filled using the fitting model using an algorithm that assumes the stair steps are uniform, and models a staircase using height and run parameters, and then calculating fitting error for each combination of height and run. By doing so, the algorithm enhances the perception of the terrain during stair traversal, allowing the robot to make more informed decisions and navigate stairs more effectively and accurately. Upon getting the heightmap information, a gradient map is calculated using a 1D convolution operation. This gradient map describes the suitability of the location in the map to place the feet on.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A system for using depth sensors on the bottom of a legged robot for stair climbing, the system further comprising of:
a plurality of depth cameras, positioned at the front and back and beneath a legged robot's central chassis to provide a comprehensive field of view,
a processor for storing depth data deriving from said depth cameras, situated within a computing box,
a point cloud, generated by way of said depth data, for leveraging data regarding said legged robot's stair climbing,
a heightmap, created by way of said point cloud and said depth data, containing terrain height information to perform a stair model fitting to estimate height and run dimensions of said stair,
a gradient map, calculated using a 1D convolution operation and said heightmap, for utilizing depth data from said plurality of depth cameras to enhance perception and decision-making and to assist with a foothold selection process, as well as determining suitable locations for said legged robot to place its feet on,
a foothold selection, utilizing a multi-objective optimization search equation for determining a distance between a current location of said legged robot and a nominal foothold location based on dynamics of said legged robot, and to enhance stability of said legged robot during the process of said foothold selection.

2. The system according to claim 1, wherein at least one of said depth cameras located at the front of said legged robot is tilted down approximately 25 degrees.

3. The system according to claim 1, wherein at least one of said depth cameras located at the back of said legged robot is tilted down 15 degrees.

4. The system according to claim 1, wherein one or more of said plurality of depth cameras are located at the center of said legged robot's central chassis and facing at an angle of 10 degrees.

5. The system according to claim 1, wherein said gradient map prefers said legged robot to step in flat terrain over uneven terrain.

6. The system according to claim 1, wherein said multi-objective optimization search equation is J=wₙₒₘJₙₒₘ+w_{grad}J_{grad}+w_{damp}J_{damp}.

7. The system according to claim 6, wherein said foothold selection and said multi-objective optimization search equation utilizes said point cloud and depth data in its calculations.

8. A method for using depth sensors on the bottom of a legged robot for stair climbing, the method comprising of:
adding downward facing depth and visual sensors to the front, back and underside the central chassis of a legged robot to provide a complete composite field of view,
positioning said downward facing depth and visual centers according to their placement on said legged robot at an angle to prevent an obscured view,
processing depth and visual sensor data with regards to an environment of said legged robot and generating a point cloud,
generating a heightmap using said depth and visual sensor data,
performing a stair model fitting to estimate height and run dimensions of said stair, and filling in missing regions in said heightmap,
calculating a gradient map based on said heightmap to aid in a foothold selection process,
and providing a persistent view of an environment being navigated.

9. The method according to claim 8, wherein said depth and visual sensor data is terrain height information.

10. The method according to claim 8, wherein said stair model fitting is 1D.

11. The method according to claim 8, wherein said data regarding said legged robot leverages depth information from said depth and visual sensors to enhance perception.

12. The method according to claim 8, wherein at least one of said visual and depth sensors is located at the front of said legged robot is tilted down approximately 25 degrees.

13. The method according to claim 8, wherein at least one of said visual and depth sensor is located at the back of said legged robot is tilted down 15 degrees.

14. The method according to claim 8, wherein at least one of said visual and depth sensors are located at the center of said legged robot's chassis and facing at an angle of 10 degrees.

15. A method for using depth sensors on the bottom of a legged robot for stair climbing, the method comprising of:
positioning a plurality of depth and visual sensors at the front, back central chassis of a legged robot to provide a comprehensive field of view of said legged robot's environment,
processing and storing depth data deriving from said depth and visual sensors using a microprocessor situated within a computing limit of said legged robot, and wherein said computing unit generates a point cloud by way of said depth data,
leveraging data regarding said legged robot's stair climbing,
creating a heightmap by way of said point cloud and depth data,
assessing terrain height information and performing a 1D stair model fitting and estimating a stair's height and run dimensions and calculating fitting errors for each combination of said height and run dimensions by changing its parameters,
filling, using a desirable stair mode that yields an optimal height and run, missing regions in a heightmap to complete a view captured by said depth and visual sensors,
calculating a gradient map, calculated using a 1D convolution operation and said heightmap utilizing depth data from said depth and visual sensors to enhance perception and decision-making and to assist with a foothold selection process, and determine suitable locations for said legged robot to place its feet on, and;
executing a multi-objective optimization search equation for determining a distance between a current location of said legged robot and a nominal foothold location based on dynamics of said legged robot, and to enhance stability of said legged robot during a foothold selection.

16. The method according to claim 15, wherein said gradient map prefers said legged robot to step on flat terrain as opposed to uneven terrain.

17. The method according to claim 15, wherein at least one of said visual and depth sensors is located at the front of said legged robot is tilted down approximately 25 degrees.

18. The method according to claim 15, wherein at least one of said visual and depth sensor is located at the back of said legged robot is tilted down 15 degrees.

19. The method according to claim 15, wherein at least one of said visual and depth sensors are located at a center of said legged robot's chassis and facing at an angle of 10 degrees.

20. The method according to claim 15, wherein said plurality of visual and depth sensors provide and capture a wide field of view with at least 90 frames per second and generate said captures are converted into said point cloud.
